(19) United States
(12) Patent Application Publication
(10) Pub. No.: US 2012/0206441 A1
(43) Pub. Date: Aug. 16, 2012

(54) DISPLAY SYSTEM AND DRIVING METHOD OF BACKLIGHT MODULE THEREOF

(75) Inventors: Hsiang-Lun Liu, Taoyuan County (TW); Ching-Huei Ku, Taipei County (TW)

(73) Assignee: CHUNGHWA PICTURE TUBES, LTD., Taoyuan (TW)

(21) Appl. No.: 13/094,840

(22) Filed: Apr. 27, 2011

(30) Foreign Application Priority Data
Feb. 11, 2011 (TW) 100104570

(51) Int. Cl. G06T 15/00; G09G 3/36; G06F 3/038

(52) U.S. Cl. 345/419; 345/211; 345/98

(57) ABSTRACT

A driving method for a display system including a display panel and a backlight module is provided. A first directional surface light source and a second directional surface light source are respectively provided by a first light source and a second light source of the backlight module through a light guide plate. Images displayed by the display panel are thus transmitted to a left eye and a right eye. A data enable signal and an image signal are received to determine whether the image signal transmits a two dimensional image or a stereoscopic image according to the data enable signal. When the image signal is the two dimensional image, the first light source and the second light source are turned on simultaneously. When the image signal is the stereoscopic image, the first light source and the second light source are turned on at corresponding display periods, respectively.

### CROSS-REFERENCE TO RELATED APPLICATION

This application claims the priority benefit of Taiwan application serial no. 100104570, filed Feb. 11, 2011. The entirety of the above-mentioned patent application is hereby incorporated by reference herein and made a part of this specification.

### BACKGROUND OF THE INVENTION

1. Field of the Invention

The invention relates to a display system and a method for driving the backlight module used therein. More particularly, the invention relates to a display system capable of switching the display of a two dimensional (2D) image and a stereoscopic (3D) image and a driving method for the backlight module used therein.

2. Description of Related Art

As technology progresses and advances, people's needs for fulfillment on a material and a spiritual level have not lessened but instead, have increased. On the spiritual level, in this age of rapid technological development, people are eager to express their imagination through a 3D display, so as to vividly experience an effect of being personally in a scene. Therefore, how to present a 3D image or video with the 3D display has become a major objective that current 3D display techniques seek to achieve.

The 3D display techniques can be roughly divided into stereoscopic techniques which require a user to wear a specially designed pair of glasses, and auto-stereoscopic techniques which directly allow viewing with a naked eye. The maturing development of the stereoscopic techniques is evident, and such techniques have found specialized applications in military simulations or large entertainment venues. However, because of unsatisfactory convenience and comfort factors of the stereoscopic techniques, these techniques have found resistance in widespread implementation. Therefore, the auto-stereoscopic techniques have gradually been developed and have become the new trend.

Specific apparatus is required for obtaining a 3D image, e.g. a camera having double lens or a combination of two cameras. Alternately, specific image processing method is needed to transform a 2D image into a 3D image. Accordingly, the 3D image is not liable to be achieved as the 2D image. Therefore, for satisfying the requirement of the market, a 3D display is requested to not only display 3D images but also display 2D images. Nowadays, the 3D display is incapable of determining whether the received image signal transmits a 3D image or a 2D image. Therefore, the image source such as an image displayer or a computer needs to transmit another signal to the 3D display for indicating whether the image signal transmits a 2D image or a 3D image. Nevertheless, such another signal is transmitted through additional signal transmitting pin such that the cost of the hardware of the 3D display or the image source is increased for achieving the 3D display normally displays a 3D image and a 2D image.

### SUMMARY OF THE APPLICATION

The invention provides a display system and a driving method for the backlight module used therein, wherein the received image signal is determined to transmit a 3D image or a 2D image according to the data enable signal provided by the image source such that the display system does not require receiving additional signals for determining whether the image signal transmits a 3D image or a 2D image and the additional cost for disposing additional pins in the hardware of the display system is left out.

The invention provides a display system including a display panel, a light guide plate, a first light source, a second light source, and a timing controller. The first light source forms a first directional surface light source through the light guide plate such that an image displayed by the display panel is transmitted to one of a left eye and a right eye. The second light source forms a second directional surface light source through the light guide plate such that the image displayed by the display panel is transmitted to the other of the left eye and the right eye. The timing controller receives a data enable signal and an image signal and is coupled to the first light source and the second light source. The timing controller determines whether the image signal transmits a 2D image or a 3D image according to the data enable signal. The timing controller turns on the first light source and the second light source simultaneously when the image signal transmits the 2D image. The timing controller turns on the first light source and the second light source at corresponding display periods when the image signal transmits the 3D image.

According to an embodiment of the invention, the timing controller determines that the image signal transmits the 2D image when a data disable period of the data enable signal is shorter than half of a data enable period of the data enable signal and determines that the image signal transmits the 3D image when the data disable period of the data enable signal is longer than or equal to half of a data enable period of the data enable signal.

According to an embodiment of the invention, the display panel is a liquid crystal display panel.

The invention further provides a driving method for a display system having a backlight module and a display panel, wherein a first light source and a second light source of the backlight module respectively form a first directional surface light source and a second directional surface light source through a light guide plate of the backlight module, such that images displayed by the display panel are respectively transmitted to a left eye and a right eye. The driving method includes following steps. A data enable signal and an image signal are received. Whether the image signal transmits a 2D image or a 3D image is determined according to the data enable signal. The first light source and the second light source are simultaneously turned on when the image signal transmits the 2D image. The first light source and the second light source are turned on at corresponding display periods when the image signal transmits the 3D image.

According to an embodiment of the invention, the step for determining whether the image signal transmits a 2D image or a 3D image according to the data enable signal includes determining that the image signal transmits the 2D image when the data disable period of the data enable signal is shorter than half of a data enable period of the data enable signal and determining that the image signal transmits the 3D image when the data disable period of the data enable signal is longer than or equal to half of a data enable period of the data enable signal.

According to an embodiment of the invention, a sum of the data disable period and the data enable period is a frame period.

According to an embodiment of the invention, the data disable period is a vertical blanking period of the frame period.

According to an embodiment of the invention, the display periods corresponding to the first light source and the second light source are respectively located at the vertical blanking periods of two adjacent frame periods.

According to an embodiment of the invention, the display periods corresponding to the first light source and the second light source are respectively shorter than and equal to the corresponding vertical blanking periods.

In view of the above, the display system and the driving method for the backlight module used therein determine whether the image signal transmits a 2D image or a 3D image according to the data enable signal in the embodiment of the invention. The timing controller turns on the first light source and the second light source simultaneously when the image signal transmits the 2D image. The timing controller turns on the first light source and the second light source at corresponding display periods when the image signal transmits the 3D image. Thereby, the timing controller can determine the format of the image transmitted by the image signal according to the data enable signal without disposing additional pins in the display system so as to reduce the cost of the hardware.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic system diagram of a display system according to an embodiment of the invention.

FIG. 2 is a schematic view showing the display system depicted in FIG. 1 displays an image.

FIG. 3 shows waveform diagrams of a data enable signal DE and pulse width modulation signals PWML and PWMR of the display system depicted in FIG. 1 according to an embodiment of the invention.

FIG. 4 shows waveform diagrams of a data enable signal DE and pulse width modulation signals PWML and PWMR of the display system depicted in FIG. 1 according to another embodiment of the invention.

FIG. 5 is a flowchart diagram depicting a driving method for driving a backlight module of the display system according to an embodiment of the invention.

### DETAILED DESCRIPTION OF EMBODIMENTS

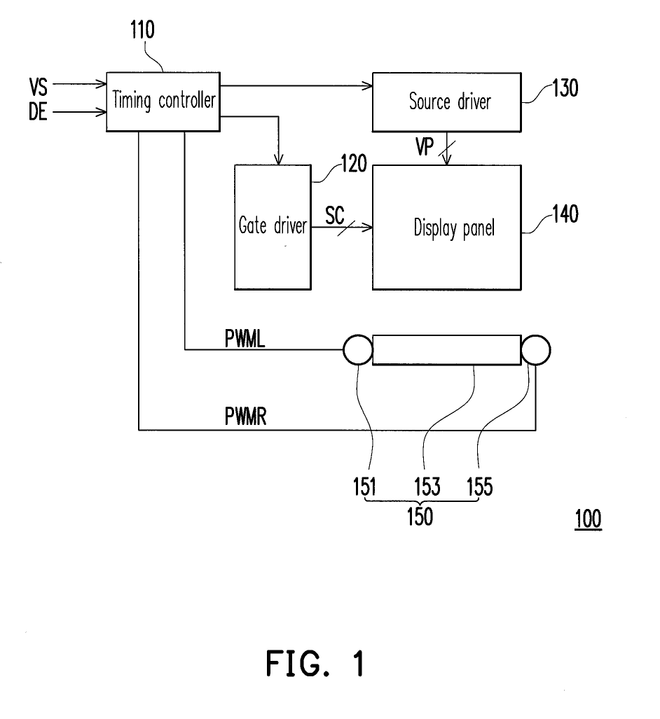

FIG. 1 illustrates a schematic system diagram of a display system according to an embodiment of the invention. Referring to FIG. 1, in the present embodiment, a display system 100 includes a timing controller 110, a gate driver 120, a source driver 130, a display panel 140, and a backlight module 150, wherein the backlight module 150 includes a first light source 151, a light guide plate 153, and a second light source 155 and the display panel 140 can be a liquid crystal display panel. The gate driver 120 is controlled by the timing controller 110 to sequentially output a plurality of scan signals SC to the display panel 140 and the source driver 130 is controlled by the timing controller 110 to output a plurality of pixel voltages VP to the display panel 140. The display panel 140 is driven by the scan signals SC such that the pixel voltages VP is input into corresponding pixels (not shown) and displays corresponding images according to the input pixel voltages VP.

The timing controller 110 receives the image signal VS and the data enable signal DE to receive the image data transmitted by the image signal VS according to the data enable signal DE. The timing controller 110 controls the gate driver 120 to output the scan signals SC according to the data enable signal DE and control the source driver 130 to output the pixel voltages VP according to the received image data. Moreover, the timing controller 110 output the pulse width modulation signals PWML and PWMR according to the data enable signal DE for respectively controlling whether the first light source 151 and the second light source 155 is turned on.

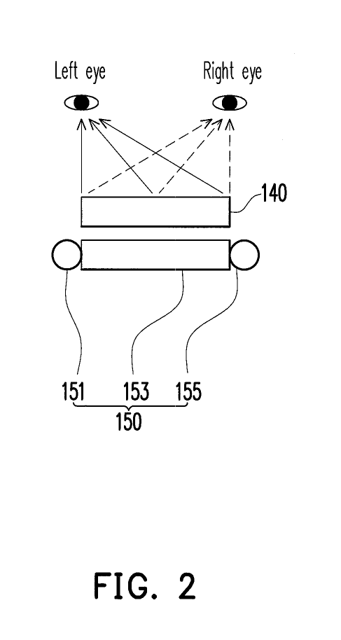

FIG. 2 is a schematic view showing the display system depicted in FIG. 1 displays an image. Referring to FIG. 1 and FIG. 2, the first light source 151 forms a first directional surface light source through the light guide plate 153 when the first light source 151 is turned on by the control of the pulse width modulation signal PWML such that the image displayed by the display panel 140 is transmitted to the left eye (as shown by the solid line). The second light source 155 forms a second directional surface light source through the light guide plate 153 to when the second light source 155 is turned on by the control of the pulse width modulation signal PWMR such that the image displayed by the display panel 140 is transmitted to the right eye (as shown by the dash line). In other embodiments, owing that the design of the light guide plate 153 is variant, the first light source 151 may form the second directional surface light source through the light guide plate 153 so that the image displayed by the display panel 140 is transmitted to the right eye (as shown by the dash line) and the second light source 155 may forms the first directional surface light source through the light guide plate 153 so that the image displayed by the display panel 140 is transmitted to the left eye (as shown by the solid line). Nevertheless, the invention is not intent to be limited to the present embodiment.

The timing controller 110 determines whether the image signal VS transmits a 2D image or a 3D image according to the data enable signal DE in the present embodiment. When the image signal VS transmits the 2D image, the adjacent frames are continuous so that the image sticking problem is prevented during displaying. Herein, the time for inputting the pixel voltages VP occupies most portion of one frame period. That is, the time that the timing controller 110 receives the image data transmitted by the image signal VS, i.e. the time that the data enable signal DE states in an enable state, occupies most portion of one frame period and the time that the timing controller 110 does not receive the image data transmitted by the image signal VS, i.e. the time that the data enable signal DE states in a disable state, is shorter (usually shorter than half of the time that the data enable signal DE states in the enable state).

On the other hand, when the image signal VS transmits the 3D image, the adjacent frames are not continuous so that the adjacent frames are separately displayed to prevent from the image sticking problem during displaying. Herein, the time for inputting the pixel voltages VP occupies more than half of one frame period. That is, the time that the data enable signal DE states in the enable state occupies more than 50% of one frame period while the time that the data enable signal DE states in the disable state is longer than or equal to half of the time that the data enable signal DE states in the enable state such that the response time of the liquid crystals in each frame is sufficient.

Accordingly, the timing controller 110 can determine whether the image signal VS transmits the 2D image or the 3D image according to the situation whether the data disable period of the data enable signal DE (the period the data enable signal states in the disable state) is shorter than half of the data enable period of the data enable signal DE (the period the data enable signal states in the enable state).

When the image signal VS transmits the 2D image, the image displayed by the display panel 140 must be simultaneously transmitted to the left eye and the right eye. In the meantime, the timing controller 110 turns on the first light source 151 and the second light source 155 simultaneously through the pulse width modulation signals PWML and PWMR. When the image signal VS transmits the 3D image, the image displayed by the display panel 140 must be alternatively transmitted to the left eye and the right eye. In the meantime, the timing controller 110 turns on the first light source 151 and the second light source 155 sequentially through the control of the pulse width modulation signals PWML and PWMR. For prevent from the image sticking problem, the first light source 151 and the second light source 155 are respectively turned on after the pixel voltages VP are input to the display panel 140. Namely, the first light source 151 and the second light source 155 are turned on at corresponding display periods, respectively.

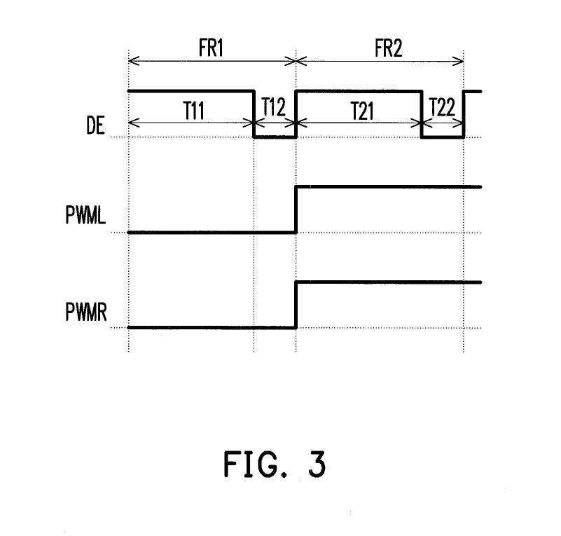

FIG. 3 shows waveform diagrams of a data enable signal DE and pulse width modulation signals PWML and PWMR of the display system depicted in FIG. 1 according to an embodiment of the invention. Referring to FIG. 3, the data disable period, i.e. the period T12, of the data enable signal DE in the frame period FR1 is ⅓ of the data enable period, i.e. the period T11, of the data enable signal DE and the data disable period, i.e. the period T22, of the data enable signal DE in the frame period FR2 is ⅓ of the data enable period, i.e. the period T21, of the data enable signal DE. The periods T12 and T22 can respectively be the vertical blanking periods of the frame periods FR1 and FR2. The sum of the periods T11 and T12 is equivalent to the frame period FR1 and the sum of the periods T21 and T22 is equivalent to the frame period FR2.

Referring to FIG. 1 and FIG. 3, the data disable period, i.e. the period T12, of the data enable signal DE in the frame period FR1 is shorter than half of the data enable period, i.e. the period T11, of the data enable signal DE such that the timing controller 110 determines that the image signal VS transmits the 2D image. Herein, the timing controller 110 can simultaneously enable the pulse width modulation signals PWML and PWMR after the frame period FR1 for simultaneously turning on the first light source 151 and the second light source 155. Generally, the image format of the image signal VS is not suddenly changed and thus the determination of the image signal VS can be ceased after the image signal VS is determined to transmit the 2D image. In an alternate embodiment, the timing controller 110 can detect the data disable period and the data enable period of the data enable signal DE in each frame so as to determine whether the image format transmitted by the signal VS is changed, which can be performed according to the requirement of the person having ordinary skill in the art and the processing ability of the timing controller 110.

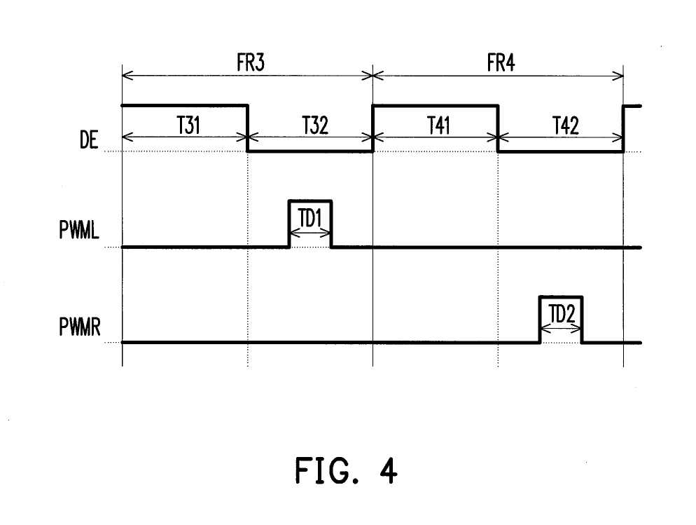

FIG. 4 shows waveform diagrams of a data enable signal DE and pulse width modulation signals PWML and PWMR of the display system depicted in FIG. 1 according to another embodiment of the invention. Referring to FIG. 4, the data disable period, i.e. the period T32, of the data enable signal DE in the frame period FR3 is equal to the data enable period, i.e. the period T31, of the data enable signal DE and the data disable period, i.e. the period T42, of the data enable signal DE in the frame period FR4 is equal to the data enable period, i.e. the period T41, of the data enable signal DE according to the present embodiment. The periods T32 and T42 can respectively be the vertical blanking periods of the frame periods FR3 and FR4. The sum of the periods T31 and T32 is equivalent to the frame period FR3 and the sum of the periods T41 and T42 is equivalent to the frame period FR4.

Referring to FIG. 1 and FIG. 4, the frame period FR3 is depicted in the follow descriptions as an example while the frame FR4 can also be taken as an example. The data disable period, i.e. the period T32, of the data enable signal DE in the frame period FR3 is longer than or equal to half of the data enable period, i.e. the period T31, of the data enable signal DE such that the timing controller 110 determines that the image signal VS transmits the 3D image. It is assumed that the frame period FR3 is the period for displaying the left eye image, and the frame period FR4 adjacent to the frame period FR3 is the period for displaying the right eye image. Herein, the timing controller 110 can enable the pulse width modulation signal PWML at the display period TD1 of the frame period FR3 to turn on the first light source 151 and enable the pulse width modulation signal PWMR at the display period TD2 of the frame period FR4 to turn on the second light source 155.

In this embodiment, the display period TD1 is set to be ⅓ of the period T32 and the display period TD2 is set to be ⅓ of the period T42. Nevertheless, in other embodiments, the display period TD1 can be shorter than or equal to the period T32 and the display period TD2 can be shorter than or equal to the period T42, which can be modified by the person who has ordinary skill in the art and the embodiment is not restricted hereto.

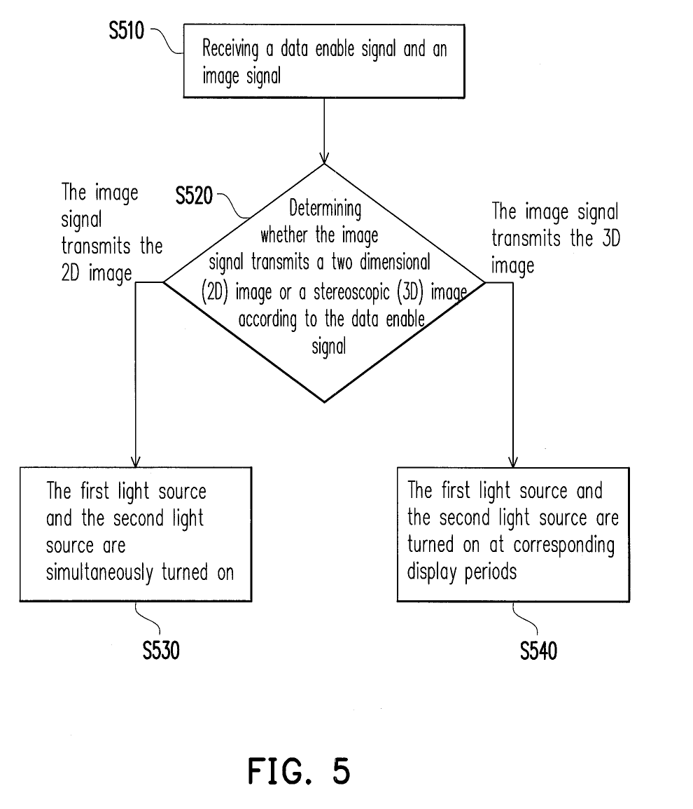

According to the above descriptions, a driving method of the backlight module can be applied in the display system 100. FIG. 5 is a flowchart diagram depicting a driving method for driving a backlight module of the display system according to an embodiment of the invention. Referring to FIG. 5, in this embodiment, the driving method of the backlight module includes first receiving a data enable signal and an image signal (step S510) and determining whether the image signal transmits a 2D image or a 3D image according to the data enable signal (step S520). The first light source and the second light source are simultaneously turned on when the image signal transmits the 2D image (step S530). The first light source and the second light source are turned on at corresponding display periods when the image signal transmits the 3D image (step S540). The details of the driving method of the present embodiment may be referred to the aforementioned descriptions of the display system 100, and therefore the description is thus omitted herein.

In light of the foregoing descriptions, the display system and the driving method for driving the backlight module used therein determine whether the image signal transmits a 2D image or a 3D image according to the data enable signal in the embodiment of the invention. The timing controller turns on the first light source and the second light source simultaneously when the image signal transmits the 2D image. The timing controller turns on the first light source and the second light source at corresponding display periods when the image signal transmits the 3D image. Thereby, the timing controller can determine the format of the image transmitted by the image signal according to the data enable signal without disposing additional pins in the display system so as to reduce the cost of the hardware.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A display system, comprising:
a display panel;
a light guide plate;
a first light source, forming a first directional surface light source through the light guide plate such that an image displayed by the display panel is transmitted to one of a left eye and a right eye;
a second light source, forming a second directional surface light source through the light guide plate such that the image displayed by the display panel is transmitted to the other of the left eye and the right eye; and
a timing controller receiving a data enable signal and an image signal and being coupled to the first light source and the second light source, wherein the timing controller determines whether the image signal transmits a two dimensional (2D) image or a stereoscopic (3D) image according to the data enable signal, the timing controller controls the first light source and the second light source to be turned on simultaneously when the image signal transmits the 2D image, and the timing controller controls the first light source and the second light source to be turned on respectively at corresponding display periods when the image transmits the 3D image.

2. The display system as claimed in claim 1, wherein the timing controller determines that the image signal transmits the 2D image when a data disable period of the data enable signal is shorter than half of a data enable period of the data enable signal and the timing controller determines that the image signal transmits the 3D image when the data disable period is longer than or equal to half of the data enable period.

3. The display system as claimed in claim 2, wherein a sum of the data disable period and the data enable period is a frame period.

4. The display system as claimed in claim 3, wherein the data disable period is a vertical blanking period of the frame period.

5. The display system as claimed in claim 4, wherein the display periods corresponding to the first light source and the second light source are respectively located at the vertical blanking periods of two adjacent frame periods.

6. The display system as claimed in claim 5, wherein the display periods corresponding to the first light source and the second light source are respectively shorter than or equal to the corresponding vertical blanking periods.

7. The display system as claimed in claim 1, wherein the display panel is a liquid crystal display panel.

8. A driving method for a display system having a backlight module and a display panel, a first light source and a second light source of the backlight module respectively forming a first directional surface light source and a second directional surface light source through a light guide plate of the backlight module, such that images displayed by the display panel are respectively transmitted to a left eye and a right eye, the driving method comprising:
receiving a data enable signal and an image signal;
determining whether the image signal transmits a 2D image or a 3D image according to the data enable signal;
turning on the first light source and the second light source simultaneously when the image signal transmits the 2D image; and
turning on the first light source and the second light source at corresponding display periods when the image signal transmits the 3D image.

9. The driving method as claimed in claim 8, wherein the step of determining whether the image signal transmits the 2D image or the 3D image according to the data enable signal comprises:
determining that the image signal transmits the 2D image when a data disable period of the data enable signal is shorter than half of a data enable period of the data enable signal; and
determining that the image signal transmits the 3D image when the data disable period of the data enable signal is longer than or equal to half of the data enable period of the data enable signal.

10. The driving method as claimed in claim 9, wherein a sum of the data disable period and the data enable period is a frame period.

11. The driving method as claimed in claim 10, wherein the data disable period is a vertical blanking period of the frame period.

12. The driving method as claimed in claim 11, wherein the display periods corresponding to the first light source and the second light source are respectively located at the vertical blanking periods of two adjacent frame periods.

13. The driving method as claimed in claim 12, wherein the display periods corresponding to the first light source and the second light source are respectively shorter than or equal to the corresponding vertical blanking periods.
